(19) United States
(12) Patent Application Publication
(10) Pub. No.: US 2003/0184650 A1
(43) Pub. Date: Oct. 2, 2003

(54) Transferring and proccessing a plurality of digital images captured by a digital camera using a computer

(75) Inventors: Robert W. Brown, Batavia, NY (US); James Doran, Rochester, NY (US); Jonathan Gary, Rochester, NY (US); Mark A. Prescott, West Henrietta, NY (US); James R. Jarrett, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/108,220

(22) Filed: Mar. 27, 2002

(51) Int. Cl. H04N 5/225

(52) U.S. Cl. 348/207.1

(57) ABSTRACT

A method of transferring a plurality of digital images captured by a digital camera to a computer and for processing such digital images includes using the digital camera to capture a plurality of digital images of one or more scenes; transferring such captured digital images to the computer wherein they are stored in a memory; and continuing the capture and transfer of digital images to the memory while simultaneously processing other digital images stored in the memory which were previously captured by the cam era wherein such processing produces digital images which are suitable for subsequent use.

### FIELD OF THE INVENTION

The present invention relates to transferring images captured by a digital camera to a computer where they are processed.

### BACKGROUND OF THE INVENTION

Digital cameras have become common in professional photography applications. Professional digital cameras, such as the Kodak Professional DCS 660 digital camera, manufactured by Eastman Kodak Company, Rochester, N.Y., permit digital images to be captured and temporarily stored, and then downloaded to a host computer. The camera includes a color image sensor, A/D converter, digital storage, and a high-speed computer interface. The host computer performs a series of digital image processing steps to convert the digital image data from the images into “finished” image files. The “finished” image files can be displayed, printed, and transferred or transmitted to other locations for use in vertising, publications, and the like.

In studio photography applications, it is desirable for the photographer to be able to take a group of pictures with his/her digital camera of a scene, and then immediately view or print these images on the host computer. However, because the images must first be downloaded and then processed, there is currently a significant time delay as each of the images is processed, before the “finished” image files are available for viewing and transmission.

In addition, some professional photography studios use several cameras at the same time, to capture various images, and several computers, to process the captured images. Currently, to process the images from several cameras, it is necessary to use several separate computers, or to serially process the captured images, one camera at a time, on a single computer.

What is needed is a flexible way of transferring digital images captured by a digital camera to a host computer, and processing the images, while permitting the photographer to continue to capture new images with the digital camera.

### SUMMARY OF THE INVENTION

It is an object of the present invention to provide an effective work flow for capturing and processing digital images.

This object is achieved by a method of transferring a plurality of digital images captured by a digital camera to a computer and for processing such digital images, comprising the steps of:

a) using the digital camera to capture a plurality of digital images of one or more scenes;

b) transferring such captured digital images to the computer wherein they are stored in a memory; and

c) continuing the capture and transfer of digital images to the memory while simultaneously processing other digital images stored in the memory which were previously captured by the camera wherein such processing produces digital images which are suitable for subsequent use.

### ADVANTAGES

It is an advantage of the present invention that the images can be transferred from a digital camera to a host computer while the computer is also processing images that have been previously transferred.

It is a further advantage of the present invention to provide a method for processing images transferred from a digital camera to a host computer while the digital camera is capturing new digital images.

It is a still further advantage of the present invention to provide a method for simultaneously transferring and processing digital images captured from a plurality of digital cameras connected to the same computer.

### BRIEF DESCRIPTION OF THE DRAWINGS

FIG. 1 depicts a block diagram of a system that implements this invention;

FIG. 2 depicts in more detail a digital camera shown as a block in FIG. 1;

FIG. 3 is a flow diagram depicting a method of transferring a plurality of digital images captured by a digital camera to a computer and processing such digital images;

FIGS. 4A-FIG. 4C depict a series of graphical user interface screens that enable a user to control a digital camera from a computer and transfer digital images to the computer;

FIG. 4D depicts a graphical user interface screen that enables a user to select digital images that have been transferred to a computer, select processing options; and

FIG. 5 is a flow diagram of the digital image processing steps that are performed on the transferred digital images.

### DETAILED DESCRIPTION OF THE INVENTION

The present invention provides an effective work flow for capturing, transferring and processing digital images from one or more digital cameras, using one or more computers. The transferred images are processed to provide “finished” image files that can be displayed, archived, printed, transmitted, and used in various publications and electronic documents, including web pages. In other words, the processed digital images are suitable for subsequent uses including color display and printing.

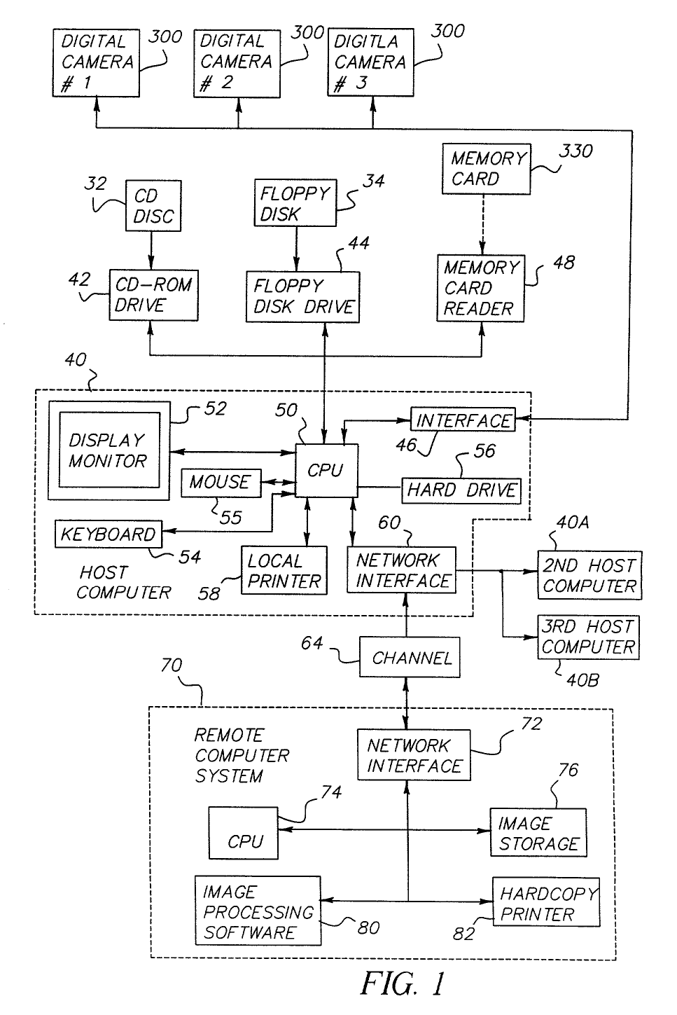

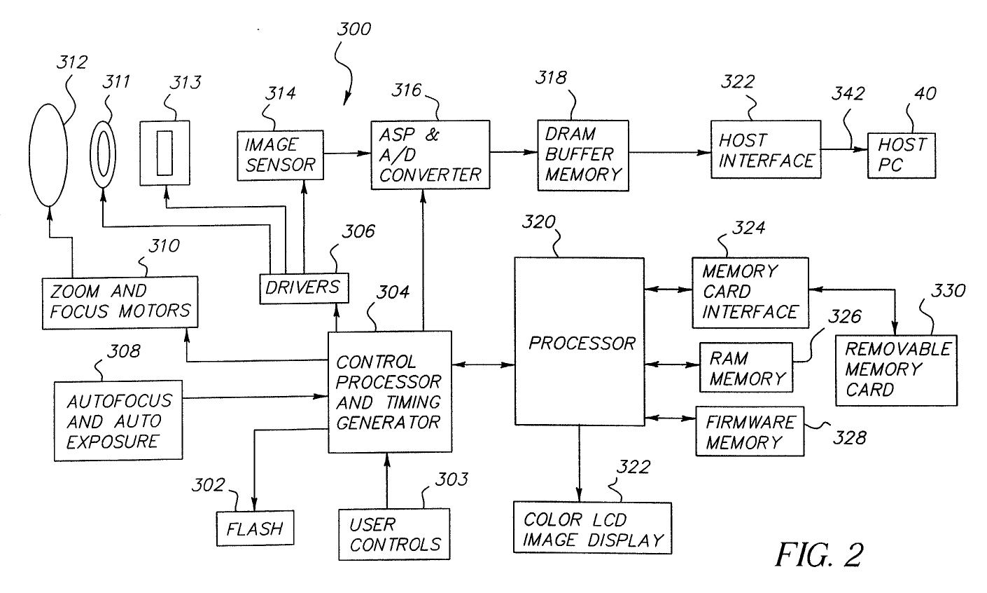

As shown in FIG. 1, the system includes a plurality of digital cameras 300, which will be described later with reference to FIG. 2. The system also includes a host computer system 40. The host computer system 40 includes a central processing unit (CPU) 50 that executes operating system and application software stored on a hard drive 56, for example, the well known Windows operating system software provided by Microsoft Corp. of Redmond, Wash. or the MacIntosh operating system provided by Apple Computer Corp. of Cupertino Calif. The operating system enables the CPU 50 to execute an application software program that performs the methods of the present invention. This application software program can be provided on a CD-ROM 32 which is read by a CD-ROM drive 42, on a floppy disk 34 which is read by a floppy disk drive 44, or by other media, or can be downloaded from the Internet.

The CPU 50 in the host computer system 40 communicates with one or more digital cameras 300 using an interface circuit 46, which connects to a wired or wireless interface 342. In a preferred embodiment, this interface conforms to the well known IEEE 1394 (“FireWire”) interface standard. Other types of interfaces, such as the well known USB, SCSI, RS-232, IRDA, Bluetooth interfaces, can alternatively be used. The CPU 50 transfers images from the cameras 300 using interface 342, and can also control the camera settings.

The CPU 40 is coupled to a display monitor 52 and a keyboard 54. A mouse 55 permits the user to readily communicate with the CPU 50. The host computer system 40 includes local printer 58 and, in some embodiments, also includes a network interface 60 for connecting to other host computer systems, including 2^{nd} host computer 40A and 3^{rd} host computer 40B.

The hard drive 56 is one type of digital storage device that can be used as a digital memory, to store images transferred from the digital cameras 300. In alternative embodiments, other types of digital storage devices can be used, for example flash memory or read/write optical disks.

In some embodiments, the network interface can also communicate over a channel 64, such as the Internet, with a network interface 72 in a remote computer system 70. The remote computer system 70 includes a CPU 74, which executes image processing software 80 to process images stored in image storage 76, both of which can use hard drives or other digital storage devices to store the image processing software and the digital images. The CPU 74 is also coupled to a hardcopy printer 82 to print processed images. Alternatively, the images processed by CPU 74 using image processing software 80 can be transferred from the remote computer system 70 to the host computer 40 for display, storage and printing on the local printer 58.

FIG. 2 is a block diagram of a preferred embodiment of the digital camera 300. The digital camera 300 produces digital images that are stored on the removable memory card 330. The removable memory card 330 can be inputted into a memory card reader 48 as is well known in the art. The digital camera 300 includes a zoom lens 312 having zoom and focus motor drives 310 and an electrically adjustable aperture 311 and an electrically driven mechanical shutter 313. The zoom lens 312 focuses light from a scene (not shown) on an image sensor 314, for example, a single-chip color CCD image sensor, using the well known Bayer color filter pattern. The aperture 311, shutter 313, and image sensor 314 are controlled by drivers 306. The zoom and focus motors 310 and the drivers 306 are controlled by control signals supplied by a control processor and timing generator circuit 304.

The control processor and timing generator 304 receives inputs from autofocus and autoexposure detectors 308 and controls a flash 302. The analog output signal from the image sensor 314 is amplified and converted to digital data by the analog signal processing (ASP) and analog-to-digital (A/D) converter circuit 316. The ASP and A/D 316 include a programmable electrical gain that can be used to adjust the effective ISO speed setting of the camera. This can be done as described in commonly assigned U.S. Pat. No. 5,610,654 to Parulski, et al., the disclosure of which is herein incorporated by reference. The digital data is stored in a DRAM buffer memory 318 and subsequently processed by a processor 320 controlled by the firmware stored in the firmware memory 328, which can be flash EPROM memory. Alternatively, the processor 320 can be provided by custom circuitry (e.g. by one or more custom integrated circuits [ICs] design only for use in digital cameras), or by a combination of programmable processor(s) and custom circuits.

The processed digital image file is provided to a memory card interface 324 which stores the digital image file on the removable memory card 330. Removable memory cards 330 are known to those skilled in the art. For example, the removable memory card 330 can include memory cards adapted to the PCMCIA card interface standard, as described in the PC Card Standard, Release 2.0, published by the Personal Computer Memory Card international Association, Sunnyvale, Calif., September 1991, or to the CompactFlash Specification Version 1.3, published by the CompactFlash Association, Palo Alto, Calif., Aug. 5, 1998. Other types of removable memory cards, including Smart Memory cards, Secure Digital (SD) cards, and Memory Stick cards, or other types of digital memory devices, such as magnetic hard drives (such as PCMCIA type III hard drives), magnetic tape, or optical disks, could alternatively be used to store the digital images.

In the preferred embodiment, the processor 320 in the digital camera 300 directly compresses the Bayer color image data from the image sensor using lossless compression, and stores the compressed data within an image file on the removable memory card 330. The image files are then transferred to the host computer system 40 and “finished” by processing the compressed Bayer color image data using the CPU 50. In alternate embodiments, uncompressed data or lossy compressed data can be stored within an image file.

The processor 320 also creates a “thumbnail” size image that is stored in RAM memory 326 and supplied to the color LCD image display 332, which displays the captured image for the user to review. In a preferred embodiment, this thumbnail image is embedded in the same image file as the lossless compressed main image. Instead of a color LCD image display, the digital camera 300 could use an organic light emitting diode (OLED) display, or many other types of image displays. The thumbnail image can be created as described in commonly assigned U.S. Pat. No. 5,164,831 to Kuchta, et al., the disclosure of which is herein incorporated by reference. The digital camera 300 is controlled by user controls 303, such as a series of user buttons including a shutter release (e.g., capture button) (not shown) which initiates a picture taking operation.

As a series of images are being captured and stored on the removable memory card 330, the interface cable 342 is used to connect between the host interface 322 in the digital camera 300 and the host computer system 40. As noted earlier, the interface cable 342 can conform to the well known IEEE 1394 interface specification, or to many other standard computer interfaces. In another embodiment, as each image is captured and packaged into an image file in RAM memory 326, the interface cable 342 is used to transfer the image file from the host interface 322 in the digital camera 300 to the host computer 40.

Alternatively, the digital camera 300 could be comprised of a digital back for a 35 mm or medium format film camera. In this case, the zoom lens 312, aperture 311, shutter 313 are provided as part of the film camera body, and the other components, including the image sensor 314, image processor 320 and color LCD image display 332 are provided as part of a separate digital camera back that is connected to the film camera body. The connection preferably includes an electrical connector (not shown), so that the zoom lens 312, aperture 311 and shutter 313 can be controlled by the control processor and timing generator 304 in the digital back.

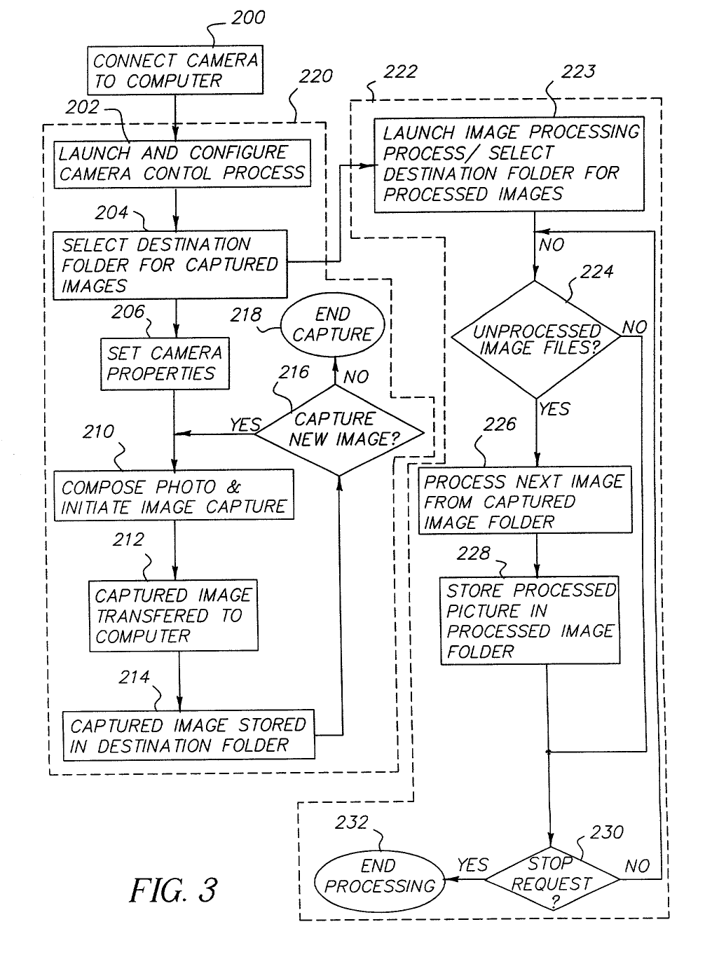

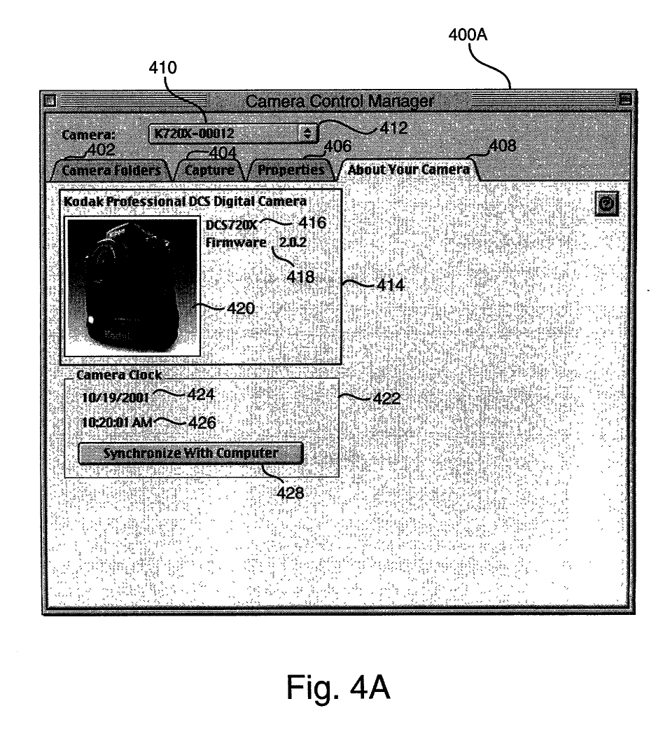

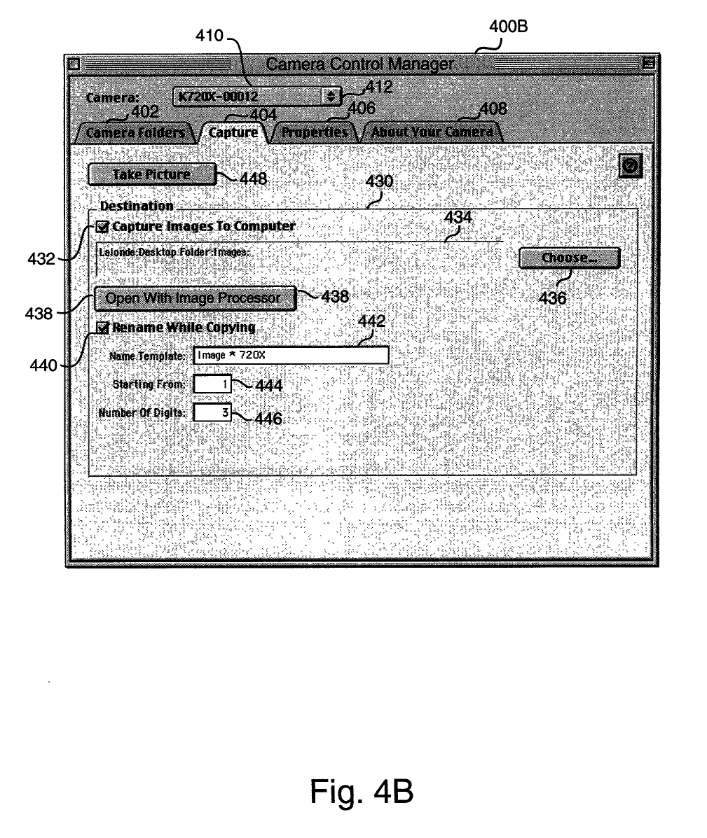

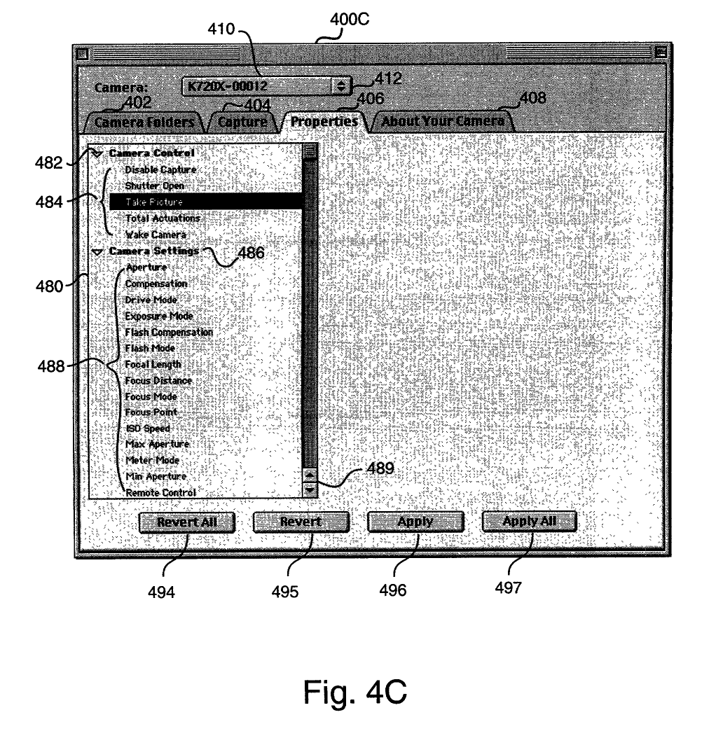

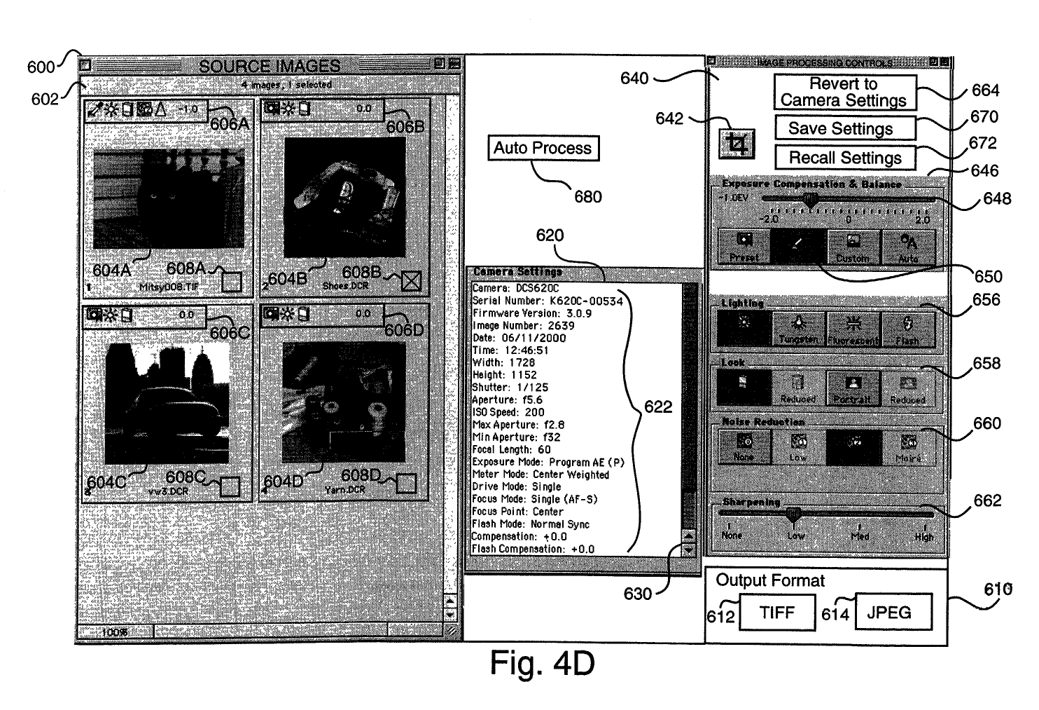

FIG. 3 is a flow diagram depicting a method of transferring a plurality of digital images captured by a digital camera to a computer and processing such digital images. In block 200, a photographer connects a digital camera 300 to the interface 46 of the host computer 40. In block 202, the camera control process which will be described later with reference to FIGS. 4A-4C is launched and configured. The camera control process can be launched by the user manually starting the software application, or by having the host computer 40 automatically start the software application upon detecting that a digital camera 300 has been connected to the interface 46.

FIG. 4A depicts a graphical user interface (GUI) screen 400A, displayed on the display monitor 52, to enable a user to control a digital camera 300 from the host computer 40 and configure the transfer of digital images to the host computer 40. GUI screen 400A includes four user-selectable tabs, a “camera folders” tab 402, a “capture” tab 404, a “properties” tab 406, and an “about your camera” tab 408, which is currently selected. GUI screen 400A also includes text window 410 and arrow icon 412 which enable the user to select a particular camera 300, if multiple cameras 300 are connected to the host computer 40. GUI screen 400A also includes a camera information area 414 which includes a camera model text string 416 (e.g. DCS 720x), a camera icon 420, and a firmware identification text string 418. The GUI screen 400A also includes a camera clock area 422 which indicates the current date 424 and the current time 426 set on the host computer 40. The camera clock area 422 also includes a “synchronize with computer” button 428 which, when selected by the user, sets the date and time of the internal clock in the digital camera 300 to be the same as the internal clock in the host computer 40.

After configuring the camera using GUI screen 400A, the photographer normally configures the image processing process using the GUI screen 600 shown in FIG. 4D. However, to facilitate understanding, discussion of FIG. 4E will be deferred until block 223 is described.

In block 204 of FIG. 3, the photographer selects a destination folder for the images to be captured by digital camera 300. To select the folder, the photographer selects the “capture” tab 404. In response, the host computer 40 displays the “capture” GUI screen 400B shown in FIG. 4B on the display monitor 52. FIG. 4B depicts the “capture” GUI screen 400B to enable a user to select a destination folder for storage of digital images that have been transferred to the host computer 40, and to optionally rename the images as they are stored.

GUI screen 400B includes a destination window 430. By selecting box 432 “capture images to computer”, each image captured by the digital camera is immediately transferred to the host computer 40, and is not stored on the removable memory card 330. If box 432 is not selected, the images are stored on the removable memory card 330 in the digital camera 300 before being transferred of to the host computer 40. Destination folder 434 can be chosen by the user using “choose” button 436.

An “Open With Image Processor” button 438, when selected, causes each captured image to be processed by the image processing software that will be described later with reference to FIG. 4F. By selecting button 438, the user launches the image processing process 222 in FIG. 3, as will be explained later.

GUI screen 400B also includes a box 440 “rename while copying” which, when selected by the user, causes the transferred image files to be renamed. The new naming convention uses the text string in text window 442 followed by a number which start with the number in text window 444, and has a number of digits equal to the value in text window 446.

In block 206 of FIG. 3, the user optionally controls the physical settings of the digital camera 300. To control the settings, the photographer selects the “properties” tab 406. In response, the host computer 40 displays the “properties” GUI screen 400C shown in FIG. 4C on the display monitor 52. FIG. 4C depicts the “properties” GUI screen 400C which includes a camera control/settings window 480. A camera control section 482 includes a plurality of control commands 484, such as “disable capture”, “shutter open”, etc. which can be individually selected by the user to instruct the digital camera 300 to perform the desired function. A camera settings section 486 includes a plurality of camera settings 488 such as “aperture”, “ISO speed”, “flash mode”, etc. which can be individually selected by the user to instruct the digital camera 300 to modif the particular setting. When the user selects a specific setting (e.g., “aperture”) a new window (not shown) is displayed, enabling the user to modify the value for that setting. A scroll control 489 enables the user to scroll through the list of camera settings 488.

GUI screen 400C also includes a “revert all” button 494, a “revert” button 495, an “apply” button 496, and a “apply all” button 497. The “apply” button 496, when pressed, instructs the digital camera 300 to apply the last command 484 or setting 488 selected by the user in the control/settings window 480. The “apply all” button 497, when pressed, instructs the digital camera 300 to apply all settings 488 previously modified by the user. The “revert” button 495, when pressed, instructs the digital camera 300 to return to the previous setting for the last setting applied. The “revert all” button 494, when pressed, instructs the digital camera 300 to return all settings to their default values.

In block 210, the photographer composes the image and initiates the image capture by the digital camera 300. Typically, the image is composed using an optical view finder (not shown) on the digital camera 300, and the photographer presses the shutter button (one of user controls 303) to initiate image capture. Alternatively, the photographer can initiate capture from the host computer 40 (e.g., by pressing the “take picture” button 448 in FIG. 4B). In response, the digital camera 300 captures the image and creates a digital image file, as was described earlier with reference to FIG. 2.

In block 212, the captured digital image file is transferred to the host computer 40. In block 214, the transferred digital image file is stored on a memory associated with the computer 40, shown as the hard drive 56 in the destination folder selected in block 204. In block 216, the user can decide to end the capture session 218 by shutting down the camera control process. In block 212, a software application program is provided associated with the computer 40. The application program includes a first process for controlling the digital camera 300 to capture images and for effecting the transfer of the captured digital images from the digital camera 300 and storage of such images in the memory associated with such computer 40. The application program also includes a second process for processing images already stored in the memory associated with the computer 40. By using the first process, the digital camera 300 is controlled to capture a plurality of digital images of one or more scenes and transferring such captured digital images to the computer 40 wherein they are stored on the digital storage device of the computer. By again using the second processes, other digital images from the memory which were previously captured are processed to provide processed digital images. In practice, a removable memory card 330 associated with the digital camera 300 can have multiple folders containing the images that are captured, and the application program can select the appropriate images to be transferred and processed. In another case, images stored in the RAM memory 326 associated with the digital camera 300 can be directly transferred to the computer 40.

Alternatively, in block 216, the user can decide to begin the capture of another image, in which case blocks 210-214 are repeated. Typically, a photographer will capture numerous digital images, repeating steps 210-214 over the course of an extended period of time ranging from several minutes to several hours.

The camera control process 220 consists of blocks 202-218 and is a first process provided by the host computer 40. This first process 220 controls the digital camera 300 to capture and store a plurality of digital images of one or more scenes, and to transfer the captured digital images to the host computer 40, where they are stored on the hard drive 56. The image processing process 222 consists of blocks 223-232 and is a second process provided by the host computer 40. As will now be described, this second process 222 will concurrently process the digital images stored on the hard drive 56 as subsequent digital images are captured using the first process 220.

In some embodiments, both the camera control process 220 and the image processing process 222 operate on the same host computer (e.g., host computer 40). In other embodiments, the camera control process 220 operates on a first computer (e.g., host computer 40) while the image processing process 222 operates on a separate different host computer (e.g., second host computer 40A). In both types of embodiment, the camera control process 220 and the image processing process 222 can operate either in succession or concurrently.

In block 223, the image processing process is launched. As part of this block the user can select a destination folder for processed images. FIG. 4E depicts a GUI screen 600 which is used to configure image processing options. These image processing options will be used in block 226 of the second process 222 to perform image processing on the digital images captured using the first process 220. The destination folder selected in the first process 220 in block 204 is used as the source image folder for the second process 222. The user optionally selects a different (i.e., final) destination folder for the processed images using a file selection mechanism (not shown). It will be understood that both the source image folder and the final destination image folder can be provided using different memory locations of the same digital storage device (e.g., hard drive 56).

The GUI screen 600 includes a image thumbnail display area 602 containing a first plurality of thumbnail images 604 (e.g., 604A-604D). In a preferred embodiment, the thumbnail image is provided using the thumbnail data which was embedded in the same image file as the lossless compressed main image, as described earlier with reference to FIG. 2. Adjacent to each thumbnail 604 is an icon display area 606 (e.g., 606A-606D). Each icon display area 606 includes a second plurality of icons which reflect the current image processing parameter values that will be used when processing the specific image file corresponding to the thumbnail 604 in block 226. Also adjacent to each thumbnail 604 is an image selection indicator 608 (e.g., 608A-608D). One or more images can be selected by using mouse 55. Selected images are identified by an “X” in the image selection indicator 608.

When a single image is selected (e.g., thumbnail image 604B as indicated by image selection indicator 608B), a camera settings window 620 is displayed. The camera settings window 620 contains a plurality of camera settings 622. These camera settings 622 were the settings used when the digital camera 300 captured the selected image. A scroll control 630 enables the user to scroll through the list of camera settings 622.

The GUI screen 600 also includes an image processing controls windows 640. The image processing controls window 640 enables the user to select image processing parameter values to be used to process the selected images identified by the image selection indicators 608. These user selected image processing parameter values can also be stored using save settings button 670. These saved image processing parameter values can be recalled using the recall settings button 672. These saved settings can also be used as default values for processing images that will be subsequently captured and automatically processed.

The image processing controls window 640 also includes a revert to camera settings button 664 which enables the user to restore the image processing parameter values as set by the digital camera 300 at the time of the original image capture.

The image processing controls window 640 includes a crop tool 642. The crop tool 642 enables the user to select a subset of the image area as represented by a thumbnail image 604. When processing the main image in block 226, only this subset of the captured image data is actually processed to create the final image (e.g., the finished image file) thereby saving processing time.

The image processing controls window 640 includes a exposure compensation and balance area 646 which includes an exposure compensation control 648. The exposure compensation control 648 enables the user to modify the exposure of the captured image data, as described in commonly assigned U.S. patent application Ser. No. 09/315,647, filed May 20, 1999, entitled “Correcting Exposure in a Rendered Digital Image” by Gilman, et al., the disclosure of which is herein incorporated by reference. The exposure compensation and balance area 646 also include four white balance control buttons 650. A preset button uses the digital camera 300 white balance setting. A click button enables the user to select an image location in a thumbnail image 604 to use as a neutral point. A custom button permits the user to apply a saved white balance setting using a custom white balance control window (not shown). An auto button instructs the image processing block 226 to use an automatic algorithm to set the white balance based on the scene content.

The image processing controls window 640 includes a lighting selection area 656 which enables the user to select one of four different lighting modes (daylight, tungsten, fluorescent, and flash). In alternative embodiments, additional lighting modes (e.g., color temperature) could be provided.

The image processing controls window 640 includes a look selection area 658 which enables the user to select one of four looks product, reduced saturation product, portrait, and reduced saturation portrait). Each look specifies a different color reproduction aim. In alternative embodiments, additional looks (e.g., Kodachrome look, Ektachrome look, monochrome look, sepia look, etc.) could be provided.

The image processing controls window 640 includes a noise reduction selection area 660 which enables the user to select one of four different noise reduction settings (none, low, medium, and moiré). In alternative embodiments, additional selections for filtering kernels could be provided.

The image processing controls window 640 includes a sharpening control area 662 which enables the user to select one of four sharpening levels (none, low, medium, and high). In alternative embodiments, additional control over the sharpening radius and threshold could be provided.

The GUI screen 600 also includes an output forma t area 610. The output format area 610 includes a JPEG compressed format button 614 and a TIFF uncompressed form at button 612 which are use d to select the format of the processed image file. In an alternative embodiment, additional compressed or uncompressed image format options (e.g., JPEG 2000, BMP, Photo CD, PICT, etc.) could be provided.

The GUI screen 600 also includes an auto process button 680 which, when selected by the user, puts the image processing process 222 into an automatic mode which will be described later. If the user does not select the auto process button 680, the image processing process operates in a manual mode which will also be described later.

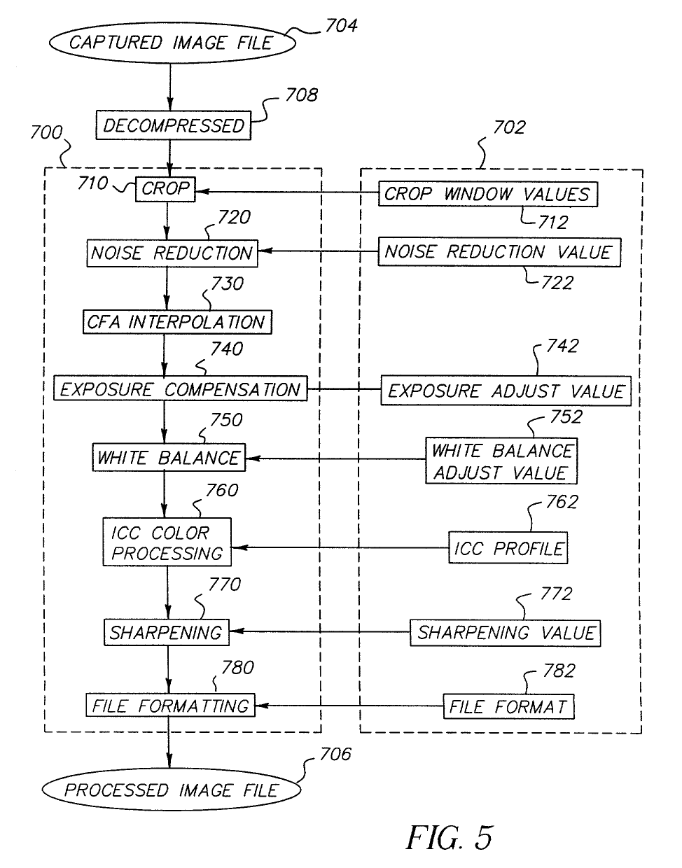

In block 224 of FIG. 3, the host computer 40 determines whether or not there are unprocessed image files. If there are none, the host computer 40 determines whether or not there is a stop request, as will be described later with reference to block 230. If there are unprocessed image files, the next image which had been selected for processing is processed in block 226, using the image processing process which will be described later with reference to FIG. 5. In block 228, the processed image is stored in the destination folder which was selected in block 223.

In block 230, the host computer 40 determines whether or not a stop request has been issued. If a stop request has not been issued, the host computer 40 proceeds to block 224 to determine if there are any unprocessed images. If a stop request has been issued, the host computer 40 shuts down the image processing process 222 in block 232.

Blocks 224-230 operate in either a manual mode or an automatic mode, depending upon whether or not the user has selected the auto process button 680. In the manual mode, the user controls when each image is processed and when the image processing process 222 is shut down. The user also selects specific images for processing as described earlier with reference to FIG. 4E. In manual mode, the GUI screen 600 shown in FIG. 4B is continually displayed during blocks 224-230, so that the user can select newly captured images provided by the camera control process 220 and select processing parameter values for these newly captured images. In the automatic mode, images are automatically queued for processing as they are delivered by the camera control process 220 as soon as they are stored in the destination folder in block 214. In this automatic mode, the image processing process 222 automatically processes images without the user needing to select specific images for processing.

FIG. 5 is a flow diagram of a preferred embodiment of the digital image processing provided in block 226 of FIG. 3. The image processing provided in blocks 700 used for a particular image is determined by image processing parameter values 702 which reflect the selections made by the user using GUI screen 600 in FIG. 4E. The captured image file 704 is the file which was stored in block 214 of FIG. 3, and the processed image file 706 is the processed file which was stored in block 228 of FIG. 3.

In block 708, the captured image file 704 is decompressed to pro provide the image data corresponding to the main image. In block 710, the uncompressed main image is cropped using crop window values 712 which were stored earlier if the user used the crop tool 642 in FIG. 4E. The crop window values 712 are the horizontal and vertical coordinates of the cropping window. If the user did not select the crop tool 642, block 710 is bypassed.

In block 720, noise reduction processing is performed using noise reduction value 722 which was stored earlier when the user selected one of the noise reduction buttons 660 in FIG. 4E. In a preferred embodiment, this noise reduction processing uses adaptive filtering of the Bayer pattern color filter array data. One method for providing such noise reduction is described in commonly assigned U.S. patent application Ser. No. 09/212,453, filed Dec. 16, 1998, entitled “Noise Cleaning and Interpolating Sparsely Populate lor Digital Image” by Edward B. Gindele, et al., the disclosure of which is herein incorporated by reference.

In block 730, the Bayer pattern color filter array data is interpolated to provide red, green and blue (RGB) image data values at each pixel location. The color filter array interpolation in block 730 can use the luminance CFA interpolation method described in commonly assigned U.S. Pat. No. 5,652,621 to Adams et. al., the disclosure of which is herein incorporated by reference. The color filter array interpolation in block 730 can also use the chrominance CFA interpolation method described in commonly assigned U.S. Pat. No. 4,642,678 to Cok, the disclosure of which is herein incorporated by reference.

In block 740, the RGB image data from block 730 is exposure compensated using exposure adjust value 742 which was stored earlier when the user selected the exposure compensation control 648 in FIG. 4E. The exposure compensation processing can use the method described in commonly assigned U.S. patent application Ser. No. 09/315,647, filed May 20, 1999, entitled “Correcting Exposure in a Rendered Digital Image” by Gilman, et al., the disclosure of which is herein incorporated by reference.

In block 750, the exposure compensated RGB data from block 740 is white balanced using white balance adjust value 752 which was stored earlier when the user selected one of the white balance controls 650 in FIG. 4E.

In block 760, the white balanced RGB data from block 750 is color processed using ICC profile 762 which was selected earlier when the user selected one of the lighting controls 656 and one of the look controls 658 in FIG. 4E.

In a preferred embodiment, the ICC color processing 760 is provided using a three-dimensional lookup table (3D LUT). An example of such a 3D LUT is described in commonly assigned U.S. patent application Ser. No. 09/540,807, filed Mar. 31, 2000, entitled “A Color Transform Method for the Mapping of Colors in Images” to Geoffrey J. Woolfe et. al., the disclosure of which is incorporated herein by reference. The 3D LUT provides the tone reproduction curve and the color reproduction aims needed to achieve the desired look for the selected lighting mode. In alternative embodiments, the ICC color processing 760 can be replaced by a single channel lookup tables and 3×3 color correction matrices as described in commonly assigned U.S. Pat. No. 5,189,511 to Parulski et al., the disclosure of which is incorporated herein by reference. The color correction matrix coefficients used to perform the processing would depend upon the selected lighting mode and look.

In block 770, the color processed RGB data from block 760 is sharpened to enhance image edge detail using sharpening value 772 which was selected earlier when the user selected the sharpening control 662 in FIG. 4E. The image sharpening provided in block 770 can use the method described in commonly assigned U.S. Pat. No. 4,962,419 to Hibbard et al., the disclosure of which is incorporated herein by reference.

In block 780, the sharpened RGB data from block 770 is formatted to provide the processed image file 706 using file format 782 which was selected earlier when the user selected one of the output formats using the output format area 610 in FIG. 4E. If the user selected the JPEG format button 614 in FIG. 4E, then block 780 provides image compression and formats the compressed image data into a JPEG file. If the user selected the TIFF format button 612 in FIG. 4E, then block 780 formats the uncompressed image data into a TIFF file.

A computer program product can include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for practicing a method according to the present invention

The invention has been described in detail with particular reference to certain preferred embodiments thereof, but it will be understood that variations to certain preferred embodiments thereof, but it will be understood that variations and modifications can be effected within the spirit and scope of the invention.

### PARTS LIST

32 CD disc

34 floppy disk

40 host computer

40A 2^{nd} host computer

40B 3^{rd} host computer

42 CD-ROM drive

44 floppy disk drive

46 interface

48 memory card reader

50 central processing unit

52 display monitor

54 keyboard

55 mouse

56 hard drive

58 local printer

60 network interface

64 channel

70 remote computer system

72 network interface

74 CPU

76 image storage

80 image processing software

82 hardcopy printer

200 connect camera to computer step

202 launch and configure camera control process step

204 select destination folder for captured images step

206 set camera properties step

210 compose photo and initiate image capture step

212 captured image transferred to computer step

214 captured image stored in destination folder step

216 capture new image decision block

218 end capture step

220 camera control process

222 Image processing process

223 launch image processing process/select destination folder for processed images

224 unprocessed image decision block

226 image processing block

228 processed image storage block

230 stop request decision block

232 end processing step

300 digital camera

302 flash

303 user controls

304 control processor and timing generator circuit

306 drivers

308 autofocus and autoexposure detectors

310 zoom and focus motor drives

311 aperture

312 zoom lens

313 shutter

314 image sensor

316 analog signal processing and analog-to-digital converter

318 DRAM buffer memory

320 processor

322 host interface

324 memory card interface

326 RAM memory

328 firmware memory

330 removable memory card

332 color LCD image display

342 interface cable

400A graphical user interface screen

400B GUI screen

400C GUI screen

402 “camera folders” tab

404 “capture” tab

406 “properties” tab

408 “about your camera” tab

410 text window

412 arrow icon

414 camera information area

416 camera model text string

418 firmware identification text string

420 camera icon

422 camera clock area

424 current date

426 current time

428 “synchronize with computer” button

430 destination window

432 “capture images to computer” box

434 destination folder

436 “choose” button

438 “Open With Image Processor” button

440 “rename while copying” box

442 text window

444 text window

446 text window

448 “take picture” button

480 control/settings window

482 camera control section

484 control commands

486 camera settings section

488 camera settings

489 scroll control

494 “revert all” button

495 “revert” button

496 “apply” button

497 “apply all” button

600 GUI screen

602 thumbnail display area

604 thumbnail images

604A thumbnail images

604B thumbnail images

604C thumbnail images

604D thumbnail images

606 icon display area

606A icon display area

606B icon display area

606C icon display area

606D icon display area

608 image selection indicator

608A image selection indicator

608B image selection indicator

608C image selection indicator

608D image selection indicator

610 output format area

612 TIFF uncompressed format button

614 JPEG compressed format button

620 camera settings window

622 camera settings

630 scroll control

640 image processing controls window

642 crop tool

646 balance area

648 exposure compensation control

650 balance control buttons

656 lighting selection area

658 look selection area

660 noise reduction selection area

662 sharpening control area

664 camera settings button

670 save settings button

672 recall settings button

680 auto process button

700 blocks

702 image processing parameter values

704 captured image file

706 processed image file

708 block

710 block

712 crop window values

720 block

722 noise reduction value

730 block

740 block

742 exposure adjust value

750 block

752 balance adjust value

760 ICC color processing

762 ICC profile

770 block

772 sharpening value

780 block

782 file format

x00 “normal” tone correction curve

x01 “slightly high contrast” tone correction curve

x02 “high contrast” tone correction curve

x03 “slightly low contrast” tone correction curve

x04 “low contrast” tone correction curve

x10 “normal” sharpening level curve

x11 “slightly sharp” curve

x12 “extra sharp” curve

x13 “slightly less sharp” curve

x14 “less sharp” curve

What is claimed is:

1. A method of transferring a plurality of digital images captured by a digital camera to a computer and for processing such digital images, comprising the steps of:
a) using the digital camera to capture a plurality of digital images of one or more scenes;
b) transferring such captured digital images to the computer wherein they are stored in a memory; and
c) continuing the capture and transfer of digital images to the memory while simultaneously processing other digital images stored in the memory which were previously captured by the camera wherein such processing produces digital images which are suitable for subsequent use.

2. The method of claim 1 wherein the subsequent use is providing images on a display or printing such images.

3. The method of claim 1 wherein, after images are processed, they are stored in different memory locations of the memory.

4. The method of claim 3 wherein the memory is a hard drive and the computer is a personal computer.

5. The method of claim 1 wherein the images captured by the digital camera are transferred over a high speed cable connection.

6. The method of claim 5 wherein the images captured by the digital camera are transferred over a high speed cable connection in accordance with the IEEE 1394 specification.

7. The method of claim 1 wherein step (c) includes using image processing parameter values selected by a user.

8. The method of claim 7 wherein different image processing parameter values can be selected for use in processing different digital images.

9. The method of claim 1 wherein the digital images processed in step (c) are selected by a user from a group of displayed thumbnail images.

10. The method of claim 9 wherein the captured digital images transferred in step (b) include embedded thumbnail images.

11. The method of claim 1 wherein the processing provided in step (c) includes color filter array interpolation processing.

12. The method of claim 1 wherein the processing provided in step (c) includes ICC color processing.

13. The method of claim 12 wherein the ICC color processing uses a particular ICC color profile determined in response to a plurality of user selections.

14. The method of claim 1 wherein the processing provided in step (c) includes white balance processing.

15. The method of claim 1 wherein the processing provided in step (c) uses image processing parameter values selected by a user prior to step (b).

16. The method of claim 15 wherein at least one image processing parameter value is modified by the user subsequent to step (b).

17. A method of transferring a plurality of digital images captured by a digital camera to at least one computer having a digital storage device and for processing such digital images, comprising the steps of:
a) providing a software application program associated with the computer, such application program including a first process for controlling the digital camera to capture images and for effecting the transfer of the captured digital images from the digital camera and storage of such images in a memory associated with the computer and a second process for processing images already stored in the memory associated with the computer;
b) using the first process to control the digital camera to capture a plurality of digital images of one or more scenes and transferring such captured digital images to the computer wherein they are stored on the digital storage device of the computer; and
c) using the second process to process other digital images from the digital storage device which were previously captured to provide processed digital images.

18. The method of claim 17 wherein the processing provides processed digital images suitable for display or printing.

19. The method of claim 17 wherein, after images are processed, they are stored in different memory locations of the memory.

20. The method of claim 19 wherein the memory is a hard drive and the computer is a personal computer.

21. The method of claim 17 wherein the images captured by the digital camera are transferred over a high speed cable connection.

22. The method of claim 21 wherein the images captured by the digital camera are transferred over a high speed cable connection in accordance with the IEEE 1394 specification.

23. The method of claim 17 further including the step of:
d) using the processed digital images to produce viewable digital images on a display.

24. The method of claim 17 further including simultaneously performing the first and second processes.

25. The method of claim 17 wherein the first process further controls the digital camera settings.

26. The method of claim 25 wherein the digital camera settings include f-stop and exposure time settings.

27. The method of claim 17 wherein the first process is implemented on a first computer and the second process is implemented on a second computer.
